(19) United States
(12) Patent Application Publication
(10) Pub. No.: US 2005/0287480 A1
(43) Pub. Date: Dec. 29, 2005

(54) Photoresist stripper composition

(76) Inventor: Masayuki Takashima, Tsukuba City (JP)

Correspondence Address: Stephen M. De Klerk;BLAKELY, SOKOLOFF, TAYLOR & ZAFMANN LLP, Seventh Floor, 12400 Wilshire Boulevard, Los Angeles, CA, 90025, US

(21) Appl. No.: 11/096,681

(22) Filed: Mar. 31, 2005

(30) Foreign Application Priority Data
Mar. 31, 2004 (JP) 2004-104341

(51) Int. Cl. G03C 5/00

(52) U.S. Cl. 430/331; 510/500

(57) ABSTRACT

(Problem) It is to provide a stripper having excellent ability to suppress corrosion or damage to the copper wiring or the low-k film, and having excellent photoresist residue removability after ashing. (Solution) The invention provides a photoresist stripper composition characterized in containing salts of at least two different inorganic acids, surfactants and a corrosion inhibitor for metal, and having a pH in the range of 3-10; and a process for preparation of semiconductor devices characterized in that the photoresist residues generated during the preparation of semiconductor devices which employs copper or a copper-dominant alloy as the material for wiring is stripped using said photoresist stripper.

### CROSS-REFERENCE TO RELATED APPLICATION

The present patent application claims priority from Japanese Patent Application No. 2004-104341, filed on Mar. 31, 2004.

### BACKGROUND OF THE INVENTION

1). Field of the Invention

The invention relates to a photoresist stripper used in semiconductor devices having copper wiring.

2). Discussion of Related Art

As photoresist strippers known hitherto, there are a stripper containing inorganic acid salts and a metal corrosion inhibitor, which acts against the wiring of an aluminum alloy or a tungsten alloy (Patent Documents 1 and 2), a stripper containing organic acid salts and surfactants (Patent Document 3) and the like.

Meanwhile, recent devices that are predominantly used have copper wiring and a film of low dielectric constant (hereinafter, referred to as a Low-k film) as the insulating film in the structure.

[Patent Document 1] Japanese Unexamined Patent Application No. 2001-51429

[Patent Document 2] Japanese Unexamined Patent Application No. 2003-223010

[Patent Document 3] Japanese Unexamined Patent Application No. 2001-267302

However, since the strippers described in the above-mentioned prior art documents work on different materials, they cannot be said to have sufficient photoresist residue removability after ashing with respect to those recently predominating devices which have copper wiring and employ Low-k film as the insulating film. Further, as the copper wiring or the Low-k film that forms the lateral side of the via holes which connect between the wires is highly susceptible to corrosion or damage under the action of reagents, there has been a need for a photoresist stripper which is excellent in inhibiting damage on copper wiring or the Low-k film, and also excellent in removing the photoresist residues.

The object of the invention is to provide a stripper which is excellent in inhibiting corrosion or damage against copper wiring or the Low-k film, and also excellent in removing the photoresist residues after ashing.

### SUMMARY OF THE INVENTION

The inventors carried out an extensive research to discover a photoresist stripper which can solve the above-described problems, and as a result, they discovered that a composition at pH 3-10 containing at least two inorganic acid salts of different acid origin, surfactants and a metal corrosion inhibitor can inhibit damages against copper wiring or Low-k films and has excellent photoresist residue removability after ashing, thus eventually accomplishing the invention.

That is, the invention is to provide a photoresist stripper characterized in containing at least two inorganic acid salts of different acid origin, surfactants and a metal corrosion inhibitor (hereinafter, referred to as the stripper of the invention), and a process for preparation of semiconductor devices using the stripper of the invention.

### BEST MODE FOR CARRYING OUT THE INVENTION

Next, the invention will be explained in detail.

The stripper of the invention contains at least two inorganic acid salts of different acid origin, surfactants and a metal corrosion inhibitor.

Here, as the inorganic acid salt, mention may be made of salts composed of components derived from inorganic acids and components derived from basic compounds.

Further, the inorganic acid may be specifically exemplified by oxo acids such as boric acid, iodic acid, phosphoric acid, diphosphoric acid, tripolyphosphoric acid, sulfuric acid, hypochlorous acid, chlorous acid, perchloric acid, nitric acid, nitrous acid, hypophosphorous acid, phosphorous acid, sulfurous acid or the like; hydrogen acids such as hydrobromic acid, hydrochloric acid, hydrofluoric acid, hydroiodic acid, hydrosulfuric acid or the like; and peroxo acids such as peroxonitric acid, peroxophosphoric acid, peroxodiphosphoric acid, peroxosulfuric acid, peroxodisulfuric acid or the like.

Among these, preferred are sulfuric acid, hydrochloric acid, nitric acid, phosphoric acid and hydrofluoric acid.

Further, as the basic compound, mention may be made of basic inorganic compounds and basic organic compounds. The basic inorganic compound may be specifically exemplified by ammonia, hydroxylamine, sodium hydroxide, potassium hydroxide, calcium hydroxide and the like. The basic organic compound may be specifically exemplified by primary amines such as methylamine, ethylamine, isopropylamine, monoisopropylamine or the like; secondary amines such as diethylamine, diisopropylamine, dibutylamine or the like; tertiary amines such as trimethylamine, triethylamine, triisopropylamine, tributylamine or the like; alkanolamines such as monoethanolamine, diethanolamine, 2-aminoethanol, 2-(ethylamino)ethanol, 2-(methylamino)ethanol, N-methyldiethanolamine, dimethylaminoethanol, diethylaminoethanol, nitrilotriethanol, 2-(2-aminoethoxy)ethanol, 1-amino-2-propanol, triethanolamine, monopropanolamine, dibutanolamine or the like; and quaternary ammonium hydroxide such as tetramethylammonium hydroxide, tetraethylammonium hydroxide, dimethyldiethylammonium hydroxide, monomethyldiethylammonium hydroxide, choline or the like.

Further, preferred basic compounds among these may include ammonia and the like among basic inorganic compounds, and tetramethylammonium hydroxide, choline and the like among basic organic compounds.

The inorganic acid salts are selected from the above-mentioned combinations. These inorganic acid salts are preferably those salts containing no metal, such as ammonia salts, and representative examples of the combination of an inorganic acid and a basic organic compound may include, for example, methylamine hydrochloride, ethylamine hydrochloride, trimethylamine hydrochloride, 2-aminoethanolamine hydrochloride, nitrilotriethanol hydrochloride, diethylaminoethanol hydrochloride, tetramethylammonium chloride, tetramethylammonium fluoride, choline chloride and the like.

Also, representative examples of the combination of an inorganic acid and a basic inorganic compound may include, for example, hydroxylamine sulfate, hydroxylamine nitrate, hydroxylamine chloride, hydroxylamine oxalate, ammonium sulfate, ammonium chloride, ammonium nitrate, ammonium phosphate, ammonium fluoride and the like.

The stripper of the invention usually contains at least two types of inorganic acid salts in an amount of 0.001-30% by weight, preferably 0.01-10% by weight, and more preferably 0.1-5.0% by weight, in total.

For the two or more inorganic acid salts, the proportion of each salt is not particularly limited, and it will be appropriate if the total percentage by weight of the salts lies within the range for the aforementioned total amount.

When the concentration of these salts is less than 0.001% by weight, the performance for removal of the photoresist residues tends to be insufficient; whereas when the concentration is higher than 30% by weight, the solubility tends to become poor. The stripper will contain at least two salts of two or more inorganic acids of different origin.

For the preferred combination of salts from the viewpoint of the photoresist residue removability, mention may be made specifically of, for example, ammonium nitrate with ammonium hydrochloride, ammonium nitrate with ammonium phosphate, hydroxylamine nitrate with hydroxylamine hydrochloride, hydroxylamine nitrate with 2-aminoethanolamine hydrochloride, and the like.

Among these, a combination of the salts of an inorganic acid and a basic inorganic compound is more preferred, and the combination of ammonium nitrate with ammonium hydrochloride, ammonium nitrate with ammonium phosphate and the like are more even more preferred.

The surfactant contained in the stripper of the invention may be any of anionic surfactants, cationic surfactants and nonionic surfactants. Among them, it is preferred that the stripper contains anionic surfactants.

Here, the anionic surfactant may include all of generally known anionic surfactants, and preferred among them are those anionic surfactants having two or more anionic functional groups in the molecular structure.

The term anionic functional group as used herein means a group having anionicity in water, and specific examples thereof may include a group forming sulfonic acid (hereinafter, referred to as sulfonic acid group), a group forming sulfuric acid ester (hereinafter, referred to as sulfuric acid ester group), a group forming phosphoric acid ester (hereinafter, referred to as phosphoric acid ester group), a group forming carboxylic acid (hereinafter, referred to as carboxylic acid group) and the like.

The compound having a sulfonic acid group may be exemplified by, specifically, compounds having two or more anionic functional groups in the molecular structure such as alkyldiphenylether disulfonic acid, alkylene disulfonic acid, the condensate of naphthalene sulfonic acid-formalin, the condensate of phenol sulfonic acid-formalin, the condensate of phenylphenol sulfonic acid-formalin or the like; compounds such as alkylbenzenesulfonic acid, dialkylsuccinate sulfonic acid, monoalkylsuccinate sulfonic acid, alkylphenoxyethoxyethyl sulfonic acid or the like, or salts thereof. The compound having a sulfuric acid ester group may be exemplified by methyltaurines such as alkylmethyltaurine, acylmethyltaurine, fatty acid methyltaurine or the like, compounds such as polyoxyalkylene alkylphenyl ether sulfuric acid esters, polyoxyalkylene alkyl ether sulfuric acid esters, polyoxyalkylene polycyclicphenyl ether sulfuric acid esters, polyoxyalkylene aryl ether sulfuric acid esters or the like, or salts thereof. The compound having a phosphoric acid ester group may be exemplified by compounds such as polyoxyalkylene alkyl ether phosphoric acid, polyoxyalkylene alkyl phenyl ether phosphoric acid or the like, or salts thereof. The compound having a carboxylic acid group may be exemplified by sarcosine compounds such as acyl sarcosine, fatty acid sarcosine or the like; and fatty acid compounds such as palm oil, oleic acid or the like, or salts thereof. The compound having two different anionic functional groups in the molecular structure may be exemplified by compounds such as alkyl sulfosuccinic acid having a sulfonic acid group and a carboxyl acid group, polyoxyalkylene alkyl sulfosuccinic acid or the like, or salts thereof.

The stripper of the invention preferably employs anionic surfactants having a sulfonic acid group and/or a sulfuric acid ester group.

Further, more preferred compounds may be those compounds having two or more anionic functional groups in the molecular structure, and even more preferred among them is alkyldiphenyl ether disulfonic acid or its salt.

As the alkyldiphenyl ether disulfonic acid or its salt, there may be specifically mentioned of disodium dodecyldiphenyl ether disulfonate, diammonium dodecyldiphenyl ether disulfonate, or ditriethanolamine dodecyldiphenyl ether disulfonate.

Cationic surfactants may include the surfactants of alkyltrimethylammonium salts, alkylamidoamines, and alkyldimethylbenzylammonium salts.

Further, nonionic surfactants may include the surfactants of polyoxyalkylene alkyl ethers, polyoxyalkylene alkylphenyl ethers, polyoxyalkylene glycol fatty acid esters, polyoxyalkylene sorbitol fatty acid esters, sorbitan fatty acid esters, polyoxyalkylene sorbitan fatty acid esters or the like.

The stripper of the invention may contain one or two or more of anionic, cationic and nonionic surfactants.

The stripper of the invention contains usually 0.001-20% by weight, preferably 0.001-10% by weight, and more preferably 0.1-5% by weight of surfactants. When surfactants are present in less than 0.001% by weight, the property of photoresist stripping tends to be insufficient; and when the concentration of surfactants is higher than 10% by weight, the viscosity or foaming of the stripper increases, thus making the handling at the time of use difficult.

The stripper of the invention contains a metal corrosion inhibitor.

Such metal corrosion inhibitor may be exemplified by organic compounds having at least one of nitrogen atom, oxygen atom, phosphorus atom and sulfur atom in the molecule, and more specifically by organic acids, saccharides, tertiary amine compounds having at least two alkyl groups at the nitrogen atom, compounds having at least one azol group in the molecule, aliphatic alcohol-based compounds having at least two carbon atoms and at least one mercapto group, wherein the carbon atom to which said mercapto group is bonded is adjacent to the carbon atom to which a hydroxyl group is bonded, or the like.

Here, the organic acids may include monocarboxylic acids such as formic acid, acetic acid, propionic acid, glyoxylic acid, pyruvic acid and gluconic acid; dicarboxylic acids such as 2-ketoglutanic acid, 1,3-acetone dicarboxylic acid, oxalic acid, malonic acid, succinic acid, glutaric acid, adipic acid, pimellic acid, maleic acid, fumaric acid and phthalic acid; oxymonocarboxylic acids such as hydroxybutyric acid, lactic acid, and salicylic acid; oxydicarboxylic acids such as malic acid and tartaric acid; oxytricarboxylic acids such as citric acid; aminocarboxylic acids such as aspartic acid and glutamic acid; and the like.

Among these, oxalic acid, malonic acid, lactic acid, gluconic acid, tartaric acid, malic acid, citric acid, glyoxylic acid and the like are preferred. They show excellent effect of corrosion inhibition with respect to copper wiring.

Saccharides may include, for example, monosaccharides such as aldoses, ketoses or the like, sugar alcohols and the like.

Specifically, aldose may be exemplified by lyxose, glyceraldehydes, treose, erythrose, arabinose, xylose, ribose, allose, altrose, gulose, idose, talose, glucose, mannose, galactose or the like; and ketose may be exemplified by erythrose, ribulose, xylose, tagatose, sorbose, psicose, fructose or the like. Sugar alcohols may be exemplified by threitol, erythritol, adonitol, arabitol, xylitol, talitol, sorbitol, mannitol, iditol, dulcitol, or the like, and sorbitol, mannitol and xylitol among them are preferred, with mannitol being more preferred.

The tertiary amine compound having at least two alkyl groups at the nitrogen atom may include amine compounds having a hydroxylalkyl group in addition to an alkyl group, amine compounds having having a cycloalkyl group in the molecule in addition to an alkyl group, polyamine compounds having two or more nitrogen atoms in the molecule, and the like.

Here, the alkyl group may be exemplified by an alkyl group having 1-4 carbon atoms, specifically a methyl group, an ethyl group, an isopropyl group, an n-propyl group, a butyl group or the like.

Among the aforementioned amine compounds, in particular, the amine compound having a hydroxylalkyl group in addition to an alkyl group may be exemplified by N,N-dimethylethanolamine, N,N-diethylethanolamine, N,N-diisopropylethanolamine, N,N-di-n-propylethanolamine or the like; and the amine compound having a cycloalkyl group may be exemplified by N,N-dimethylcyclohexylamine, N,N-diethylcyclohexylamine, N,N-diisopropylcyclohexylamine, N,N-di-n-propylcyclohexylamine, N,N-dibutylcyclohexylamine or the like. Further, the polyamine compound having two or more nitrogen atoms in the molecule may be exemplified by tetramethylethylenediamine, tetramethylpropanediamine, tetramethylbutanediamine, tetramethylpentanediamine, tetramethylhexanediamine, pentamethyldiethylenetriamine, bis(dimethylaminoethyl) ether, tris(3-dimethylaminopropyl) hexahydro-S-triazine or the like.

Among these, dimethylcyclohexylamine, pentamethyldiethylenetriamine and bis(2-dimethylaminoethyl) ether are preferred.

Specific examples of the compound having at least one azol group in the molecule may include, for example, benzotriazole derivatives such as benzotriazole, tolyltriazole, 4-methylimidazole, 5-hydroxymethyl-4-methylimidazole, 3-aminotriazole, 1-hydroxybenzotriazole, 2,2′-[[(methyl-1H-benzotriazol-1-yl)methyl]imino]bis-ethanol and the like.

Specific examples of the aliphatic alcohol-based compounds having two or more carbon atoms and at least one mercapto group, wherein the carbon atom to which said mercapto group is bonded is adjacent to the carbon atom to which a hydroxyl group is bonded, may include, for example, thioglycerol, thioglycol and the like.

The stripper of the invention may contain two or more types of these metal corrosion inhibitors.

The stripper of the invention usually contains these metal corrosion inhibitors in an amount of 0.0001-10% by weight, preferably 0.001-5% by weight, and more preferably 0.01-2% by weight. When the content is less than 0.0001% by weight, the effect of corrosion inhibition against copper wiring tends to be insufficient; and when the content is greater than 10% by weight, the solubility in the stripper tends to be insufficient.

The pH of the stripper of the invention is usually 3-10, and preferably 4-9. When pH is lower than 3, the photoresist residue removability may become insufficient occasionally; and when pH is higher than 10, the property of inhibiting damage against the Low-k film may become poor.

The stripper of the invention may contain a pH adjusting agent, if necessary. The pH buffering agent used in such cases may be an acid or basic solution generally used, which preferably does not contain metal.

Further, the aforementioned inorganic acid and basic compound may be contained in the stripper of the invention as general pH adjusting agents.

The stripper of the invention contains water as the solvent.

The stripper of the invention contains water usually in an amount of 40-99.98% by weight, preferably 50-99.98% by weight, more preferably 70-99.98% by weight, and particularly preferably 90-99.98% by weight.

In addition, although the photoresist strippers of prior art have been in general an agent containing organic solvents as the main component, the stripper of the invention contains water as the main component and still exhibits an excellent effect of photoresist stripping. Recently, agents having water as the main component have been on demand for the reason of lowering the environmental load, and the stripper of the invention also preferably contains plenty of water.

Further, the stripper of the invention may contain a water-soluble organic solvent as solvent, if necessary. Such water-soluble organic solvent as used for the purpose may be, for example, general alcohols such as methanol, ethanol, isopropyl alcohol or the like, glycols such as ethylene glycol, ethylene glycol monomethyl ether, ethylene glycol monoethyl ether, ethylene glycol monoisopropyl ether, ethylene glycol monobutyl ether, diethylene glycol, diethylene glycol monomethyl ether, diethylene glycol monoethyl ether, diethylene glycol monoisopropyl ether, diethylene glycol monobutyl ether or the like, N-methyl-2-pyrrolidone, dimethyl sulfoxide or the like..

When these water-soluble organic solvents are contained, the content is in the range of 5% to 30% by weight with respect to the total amount of the stripper of the invention.

Further, the stripper of the invention may contain other components if necessary, within the scope of not deviating from the purpose of the invention.

Such other components may include, for example, aqueous hydrogen peroxide, defoamer and the like.

As the defoamer, mention may be made specifically of, for example, emulsifiers such as silicones, polyethers, special nonionics, fatty acid esters or the like, and water-soluble organic compounds such as methanol, ethanol, 1-propanol, 2-propanol, 2-methyl-1-propanol, acetone, methyl ethyl ketone or the like.

When the stripper of the invention contains these other components, the total amount is usually in the range of 0.01% - 5% by weight, and preferably 0.1%-1% by weight.

The stripper of the invention is adjusted by a method equivalent to the generally known method for preparation of photoresist stripper. Specifically, the stripper is obtained by mixing, for example, a solvent with components such as two or more types of inorganic acid salts, surfactants, a metal corrosion inhibitor or the like. Or else, it is also possible to mix the inorganic acids or basic compounds separately in their respective equivalents required in the formation of salts. More concretely, it is possible to obtain the stripper by mixing, for example, aqueous ammonia, hydrochloric acid and nitric acid in a solvent to their respective required salt concentrations, collecting the exotherm resulting from the heat of neutralization, and then mixing other surfactants, metal corrosion inhibitors or the like sequentially and dissolving them.

Furthermore, the stripper of the invention may be prepared as a stock solution containing relatively high concentrations of the respective components, and the stock solution can be diluted with water to the stripper of the invention of the original concentration at the time of use. This method is advantageous when the site of stripper preparation and the site of use are geographically separated, from the viewpoint of lowering the transportation costs, facilitating the securing of the storage space or the like.

The stripper of the invention is used for a substrate that is used in the preparation of semiconductor devices in which the wiring material to be connected to elements such as transistor is constituted of copper or a copper alloy having copper as the predominant component.

Here, the copper alloy having copper as the predominant component means copper alloys containing 90% by mass or more of copper and includes copper alloys containing heterogeneous elements such as Sn, Ag, Mg, Ni, Co, Ti, Si, Al or the like. These metals improve the high-speed performance of elements with their property of low resistance, while they are susceptible to corrosion such as dissolution, deterioration or the like in reagents, thus making the effect of the invention conspicuous.

As the film to be treated with the stripper of the invention, mention can be made of the Low-k film which is a recently used interlayer insulating film between the wiring, the silicon oxide film which is a conventional interlayer insulating film, or the like.

The Low-k film which can be the subject of treatment by the stripper of the invention may be anything, regardless of the type of the film or the film-forming method, as long as it is generally known. The Low-k film as used herein conventionally means an insulating film with a dielectric constant of 3.0 or less.

Such Low-k film may be, for example, inorganic films such as FSG (F-containing SiO₂), SiOC (carbon-containing SiO₂) and SiON (N-containing SiO₂); polyorganosiloxane-based films such as MSQ (methylsilsesquioxane), HSQ (hydrogensilsesquioxane), MHSQ (methylated hydrogensilsesquioxane) or the like; aromatic films such as PAE (polyarylether), BCB (divinylsiloxane-bis-benzocyclobutene) or the like; and organic films such as SiLk, porous SiLk or the like.

In particular, the film suitable for the treatment by the stripper of the invention may include SiOC, MSQ, PAE (polyarylether) and the like.

The method for photoresist residue removal using the stripper of the invention may include an immersion method in which a semiconductor substrate is directly immersed in the stripper of the invention; a spray method in which the stripper of the invention is sprayed onto 25-50 substrates while rotating them; a single wafer spinning method in which the stripper of the invention is sprayed onto one substrate while rotating it; and the like.

As the method for preparation of semiconductor devices using the stripper of the invention, for example, the following method may be mentioned.

First, an insulating film such as silicon oxide film is formed on the semiconductor substrate onto which elements such as transistor and the like have been formed, and copper wiring is formed on the insulating film using the known CMP technology and lithography technology. Subsequently, a Low-k film or silicon dioxide film, silicon nitride film or the like is formed on the copper wiring.

Next, after patterning of photoresist by means of lithography technology, the photoresist is used as the mask, and via holes are formed in the dielectric film or the like using the dry etching technology. Upon the formation of via holes, the residues produced by etching are attached onto the inner wall of the holes. Subsequently, the photoresist is removed by ashing with oxygen plasma or the like, and again, the residues remaining on the bottom or inner wall of the via holes and in the periphery of the via holes are stripped by means of the stripper of the invention. Thus, the photoresist film or etching residues that could not be removed by ashing can be removed.

Then, a film of copper or tungsten is embedded inside the via holes to form an interlayer connecting plug.

In the preparation of the devices, as described above, since the copper wiring layer is exposed at the opening of the via holes after etching, and the low-dielectric constant film is exposed at the inner wall of the holes, the stripper of the invention is required to have the anti-corrosive action against copper or the property to inhibit damage against the low-dielectric constant film. By using the stripper of the invention in the process for preparation of devices, it is possible to remove the photoresist residues and etching residues effectively without damaging the copper layer or the low-dielectric constant film.

### EXAMPLE

Next, the invention will be explained in more detail by the following Example, which is not intended to limit the invention in any way.

### Example 1

In the process for via hole formation on the copper wiring, the photoresist residue removability after ashing and the ability of damage inhibition against the copper wiring and the Low-k film of the stripper of the invention were evaluated.

The sample provided for the evaluation was prepared in the following manner.

First, copper wiring was formed on silicon wafer, and then a SiOC film, which is a Low-k film, was formed thereon by means of the plasma CVD technique. Next, a positive-type photoresist film was formed thereon, exposed and developed to yield a photoresist pattern.

This photoresist film was used as the mask in dry etching the Low-k film, and via holes were formed. After completion of etching, the photoresist film was subjected to ashing by means of oxygen plasma ashing, and then the stripping treatment was carried out using the stripper of the invention having the composition as presented in Table 1 and comparative strippers, with respect to the sample on which photoresist residues remain attached after ashing. As the pH adjusting agent, tetramethylammonium hydroxide was used.

For the conditions for the stripping treatment, the sample was rotated at 500 rpm, subjected to single wafer spinning for 1 minute at a flow rate of 150 ml/min of the stripper, and then rinsed with water for 10 seconds. Subsequently, the sample was observed at the cross-section by SEM (scanning electronic microscopy). The photoresist residue removability for the residues inside the holes, the corrosiveness against the copper layer exposed on the bottom of the via holes, and the damage on the exposed Low-k film (SiOC) surface were evaluated. The results are presented in Table 1. Further, in Table 1, the values for the respective components represent the percentage by weight, and the value for the pH represents the pH value for the solution after combining.

TABLE 1

| | Stripper | Compar- | Compar- | Compar- |
|---|---|---|---|---|
| | of the | ative | ative | ative |
| | Invention 1 | Stripper 1 | Stripper 2 | Stripper 3 |
| Ammonium nitrate | 0.4 | 0.4 | 0.4 | 0.4 |
| Ammonium chloride | 0.8 | | 0.8 | 0.8 |
| Oxalic acid | 0.1 | 0.1 | 0.1 | 0.1 |
| Diammonium | 0.25 | 0.25 | 0.25 | |
| dodecyldiphenyl | | | | |
| ether disulfonate* | | | | |
| pH adjusting agent | 0.20 | 0.20 | | 0.20 |
| Water | 98.25 | 99.05 | 98.45 | 98.50 |
| pH | 5.0 | 5.0 | 2.0 | 5.0 |
| In-hole residue | ∘ | x | ∘ | x |
| removability | | | | |
| Corrosiveness | ∘ | ∘ | ∘ | ∘ |
| against copper | | | | |
| layer | | | | |
| Damage on Low-k | ∘ | ∘ | x | ∘ |
| film | | | | |

*Anionic surfactant having two anionic functional groups
[Criteria for evaluation]
Residue removability: ∘ Good
Δ Slightly insufficient
x Insufficient
Corrosiveness against copper layer: ∘ No corrosion
Δ Slight corrosion
x Severe corrosion
Damage on Low-k film: ∘ No damage
Δ Slight damage
x Severe damage

[Criteria for Evaluation]
Residue Removability:
∘ Good
Δ Slightly insufficient
x Insufficient
   Corrosiveness Against Copper Layer:
∘ No corrosion
Δ Slight corrosion
x Severe corrosion
   Damage on Low-k Film:
∘ No damage
Δ Slight damage
x Severe damage

As shown in Table 1, the stripper of the invention 1 has good in-hole residue removability, and does not show any corrosion of the copper layer that is exposed on the bottom of the holes and the damage of the Low-k film that is exposed on the side wall of the holes. Meanwhile, in Comparative Stripper 1 which contained only one type of non-metallic salt, the in-hole residue removability was lowered, and in Comparative Stripper 2 having a low pH of 2.0 and in Comparative Stripper 3, containing no surfactant, damage on the Low-k film was observed.

### EFFECT OF THE INVENTION

According to the invention, it is possible to provide a photoresist stripper which has excellent property of inhibiting the corrosion against the copper wiring or the Low-k film, or to damages, and excellent photoresist residue removability after ashing.

1. A photoresist stripper composition containing two or more inorganic acid salts of different acid origin, surfactants and a metal corrosion inhibitor, characterized in that the composition pH is in the range of 3 to 10.

2. The photoresist stripper composition according to claim 1, wherein at least one of the two or more inorganic salt acids is a salt consisting of an inorganic acid and a basic inorganic compound.

3. The photoresist stripper composition according to claim 1, wherein at least one of the two or more inorganic salt acids is a salt consisting of an inorganic acid and a basic organic compound.

4. The photoresist stripper composition according to claim 1, characterized in that the two or more inorganic acid salts are salts selected from nitrates, chlorides and phosphates.

5. The photoresist stripper composition according to claim 1, characterized in that the surfactants are anionic surfactants.

6. The photoresist stripper composition according to claim 1, characterized in that the metal corrosion inhibitors are organic acids.

7. A process for preparation of semiconductor devices, characterized in that the photoresist residues produced during the preparation of semiconductor devices which use copper or a copper alloy having copper as the predominant component as the material for wiring, are stripped by means of the photoresist stripper composition as described in claim 1.
